(19) United States
(12) Patent Application Publication
(10) Pub. No.: US 2008/0212935 A1
(43) Pub. Date: Sep. 4, 2008

(54) Playback apparatus, playback method, and program

(76) Inventor: Mitsutoshi Shinkai, Kanagawa (JP)

Correspondence Address: FROMMER LAWRENCE & HAUG LLP, 745 FIFTH AVENUE, NEW YORK, NY, 10151, US

(21) Appl. No.: 12/008,248

(22) Filed: Jan. 9, 2008

(30) Foreign Application Priority Data
Jan. 11, 2007 (JP) P2007-003370

(51) Int. Cl. G11B 27/00; H04N 5/93

(52) U.S. Cl. 386/52

(57) ABSTRACT

A playback apparatus playing back video data and low-resolution data obtained by decreasing the resolution of the video data which are stored in a recording medium includes a reading unit configured to read the video data and the low-resolution data from the recording medium, a synthesizing unit configured to synthesize the read video data and the read low-resolution data, and a display control unit configured to, on the basis of synthesized data obtained as a result of the synthesis, simultaneously display source video corresponding to the video data in a first screen of a display device and low-resolution video corresponding to the low-resolution data in a second screen of the display device which is smaller than the first screen.

### CROSS REFERENCES TO RELATED APPLICATIONS

The present invention contains subject matter related to Japanese Patent Application JP 2007-003370 filed in the Japanese Patent Office on Jan. 11, 2007, the entire contents of which are incorporated herein by reference.

### BACKGROUND OF THE INVENTION

1. Field of the Invention

The present invention relates to playback apparatuses, playback methods, and programs. In particular, the present invention relates to a playback apparatus, a playback method, and a program which enhance operability for users in editing of video data.

2. Description of the Related Art

In video editing using a video tape recorder (VTR), in general, a user uses two VTRs, one for playing back video source material to be edited and another for recording editing results and performs editing operations while viewing video images displayed on display devices provided in the individual VTRs.

Optical disc apparatuses have also been used in video editing which allow users to perform nonlinear editing on video data stored in single optical discs. An example of such optical disc apparatuses is disclosed in United States Patent Application Publication No. 2005/0008327. When a user performs editing using such an optical disc apparatus, the user searches for a video image at a start point of a video section to be edited (editing section) (hereinafter referred to as an in-point) and a video image at an end point of the editing section (hereinafter referred to as an out-point), from video displayed on the basis of video data, for example. The user then sets the time code of the video image at the in-point as an in-point and sets the time code of the video image at the out-point as an out-point for use in the editing.

### SUMMARY OF THE INVENTION

In such an editing process, no technique has been developed to enhance operability for users by simultaneously displaying a plurality of video images to be edited.

Specifically, in retrieval of a video image at an in-point of an editing section, if an optical disc apparatus simultaneously displays video source material for the retrieval and a video image at the out-point of the immediately preceding editing section which is to be connected to the in-point being set, a user can set the in-point while viewing the video image at the out-point. This allows the user to easily retrieve a video image corresponding to the set in-point and as a result enhances operability in editing. However, there is no technique in which a plurality of video images to be edited are displayed simultaneously.

The present invention has been made in view of the above circumstances, in which there is a need for a technique for enhancing operability in video data editing.

According to an embodiment of the present invention, a playback apparatus playing back video data and low-resolution data obtained by decreasing the resolution of the video data which are stored in a recording medium includes a reading unit configured to read the video data and the low-resolution data from the recording medium, a synthesizing unit configured to synthesize the read video data and the read low-resolution data, and a display control unit configured to, on the basis of synthesized data obtained as a result of the synthesis, simultaneously display source video corresponding to the video data in a first screen of a display device and low-resolution video corresponding to the low-resolution data in a second screen of the display device which is smaller than the first screen.

According to an embodiment of the present invention, the playback apparatus further includes a low-resolution specifying unit configured to specify a time code value of low-resolution video to be displayed in the second screen, a start point specifying unit configured to specify a time code value of low-resolution video displayed in the second screen as a start point of an editing section of source video to be edited, an instructing unit configured to instruct display of source video in the first screen which corresponds to a time code value identical to a time code value of low-resolution video currently displayed in the second screen, an end point specifying unit configured to specify a time code value of low-resolution video displayed in the second screen as an end point of the editing section, and an editing unit configured to record the specified start point and the specified end point of the editing section in the recording medium as editing information representing a result of editing. In response to an instruction sent by the instructing unit, the synthesizing unit synthesizes low-resolution data of low-resolution video currently displayed in the second screen and video data of source video corresponding to a time code value identical to the time code value of the currently displayed low-resolution video, and when a time code value of low-resolution video is specified by the low-resolution specifying unit, synthesizes low-resolution data corresponding to the specified time code value and video data of source video corresponding to a time code value identical to the time code value of low-resolution video displayed in the second screen at the time of the instruction by the instructing unit.

According to an embodiment of the present invention, the playback apparatus further includes a low-resolution specifying unit configured to specify a time code value of low-resolution video to be displayed in the second screen, a display instructing unit configured to instruct display of source video in the first screen which corresponds to a time code value identical to a time code value of low-resolution video currently displayed in the second screen, a change instructing unit configured to instruct a change in a time code value of source video to be displayed in the first screen from a time code value of source video displayed in the first screen at the time of the instruction by the display instructing unit to a desired time code value of source video, a start point specifying unit configured to specify a time code value of source video displayed in the first screen as a start point of an editing section of source video to be edited, an end point specifying unit configured to specify a time code value of source video displayed in the first screen as an end point of the editing section, and an editing unit configured to record the specified start point and the specified end point of the editing section in the recording medium as editing information representing a result of editing. In response to an instruction sent by the display instructing unit, the synthesizing unit synthesizes low-resolution data of low-resolution video currently displayed in the second screen and video data of source video corresponding to a time code value identical to a time code value of the currently displayed low-resolution video, and when a time code value is specified by the low-resolution specifying unit, the synthesizing unit synthesizes low-resolution data corresponding to the specified time code value and video data of source video displayed in the first screen at an immediately preceding time point and, in response to an instruction by the change instructing unit, synthesizes low-resolution data of low-resolution video displayed in the second screen at an immediately preceding time point and video data corresponding to the desired time code value of source video.

According to an embodiment of the present invention, a playback method for a playback apparatus playing back video data and low-resolution data obtained by decreasing the resolution of the video data, which are recorded in a recording medium, includes the steps of reading the video data and the low-resolution data from the recording medium, synthesizing the read video data and the read low-resolution data, and on the basis of synthesized data obtained as a result of the synthesis, simultaneously displaying source video corresponding to the video data in a first screen of a display device and low-resolution video corresponding to the low-resolution data in a second screen of the display device which is smaller than the first screen.

According to an embodiment of the present invention, a program causing a computer to execute playback processing for playing back video data and low-resolution data obtained by decreasing the resolution of the video data, which are recorded in a recording medium, including the steps of reading the video data and the low-resolution data from the recording medium, synthesizing the read video data and the read low-resolution data, and on the basis of synthesized data obtained as a result of the synthesis, simultaneously displaying source video corresponding to the video data in a first screen of a display device and low-resolution video corresponding to the low-resolution data in a second screen of the display device which is smaller than the first screen.

According to an embodiment of the present invention, video data and low-resolution data obtained by decreasing the resolution of the video data are read from a recording medium. The read video data and the low-resolution data are synthesized. On the basis of synthesized data obtained as a result of the synthesis, source video corresponding to the video data in a first screen of a display device, and at the same time low-resolution video corresponding to the low-resolution data is displayed in a second screen of the display device which is smaller than the first screen.

A playback apparatus according to an embodiment of the present invention may be provided as an independent apparatus or as a block in a recording/playback apparatus for performing playback processing.

### BRIEF DESCRIPTION OF THE DRAWINGS

FIG. 1 is a block diagram illustrating an example of a configuration of an optical disc apparatus according to an embodiment of the present invention;

FIG. 2 is a block diagram illustrating an example of a functional configuration of an editing section;

FIG. 3 illustrates an example of a directory structure of files recorded in an optical disc;

FIGS. 4A to 4C illustrate examples of formats of a clip file and a proxy file;

FIG. 5 illustrates a recording position of data of a clip file and a proxy file on an optical disc;

FIG. 6 illustrates an example of an edit list of an edit list file;

FIG. 7 illustrates a parent screen and a child screen provided in a display area of a display device;

FIG. 8 illustrates an operation surface of an editing operation section;

FIG. 9 illustrates editing operations;

FIG. 10 illustrates editing operations;

FIG. 11 illustrates editing operations;

FIG. 12 is a flowchart illustrating details of editing processing;

FIG. 13 is a flowchart illustrating details of editing processing;

FIG. 14 is a flowchart illustrating details of editing processing;

FIG. 15 is a flowchart illustrating details of editing processing; and

FIG. 16 is a flowchart illustrating details of editing processing.

### DESCRIPTION OF THE PREFERRED EMBODIMENTS

In the following, the preferred embodiments of the present invention will be described with reference to the drawings.

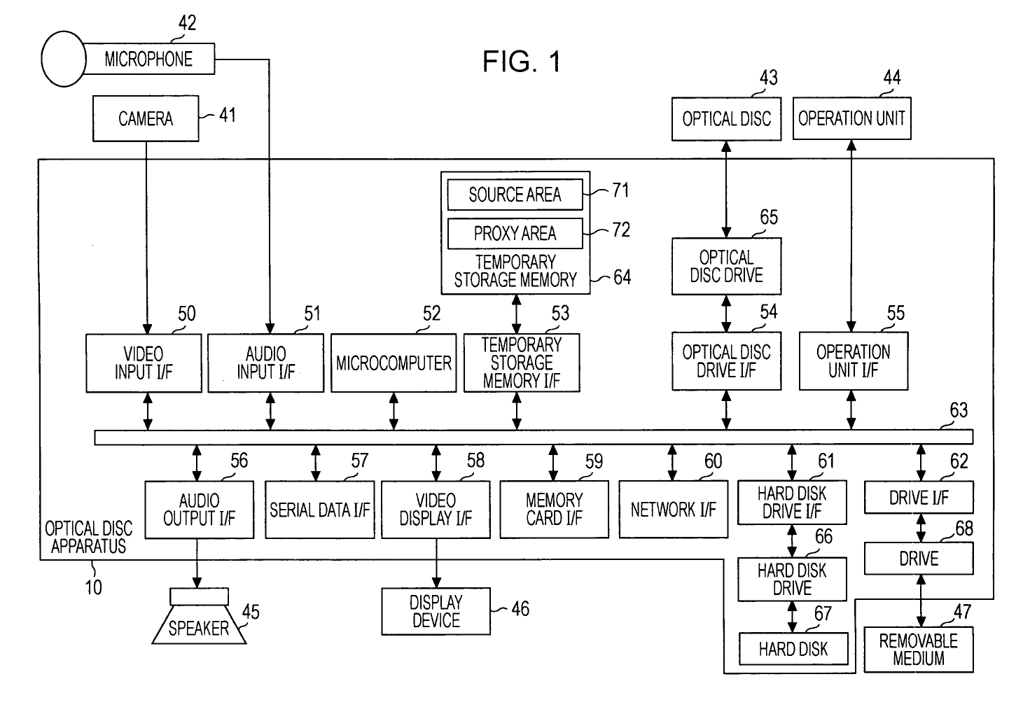

FIG. 1 is a block diagram illustrating a configuration of an optical disc apparatus 10 according to an embodiment of the present invention.

In the optical disc apparatus 10 in FIG. 1, a video input interface (I/F) 50, an audio input I/F 51, a microcomputer 52, a temporary storage memory I/F 53, an optical disc drive I/F 54, an operation unit I/F 55, an audio output I/F 56, a serial data I/F 57, a video display I/F 58, a memory card I/F 59, a network I/F 60, a hard disk drive I/F 61, and a drive I/F 62 are interconnected via a system bus 63.

The video input interface I/F 50 is connected to an external camera 41 and receives input of video signals obtained through image capturing performed by the camera 41. The video input interface I/F 50 supplies signals which complies with SDI (serial digital interface) standard as video data to the microcomputer 52, the video display I/F 58, and temporary storage memory I/F 53 via the system bus 63. Such signals include synchronous signals such as composite signals and component signals.

The audio input I/F 51 is connected to an external microphone 42 and receives input of audio signals from the microphone 42 which are analog signals of audio captured by the microphone 42. The audio input I/F 51 performs analog/digital (A/D) conversion on the received signals and supplies the resultant digital signals as audio data to the microcomputer 52 or the temporary storage memory I/F 53 via the system bus 63.

The microcomputer 52 includes a CPU (central processing unit), a ROM (read-only memory), and a RAM (random access memory). The CPU of the microcomputer 52 controls the individual components of the optical disc apparatus 10 in response to an operation signal supplied from the operation unit I/F 55, in accordance with a program stored in the ROM or a hard disk 67.

For example, the CPU receives video data supplied by the video input interface I/F 50 and audio data supplied by the audio input I/F 51. Using audio/video source material data (hereinafter simply referred to as source data) composed of the video data and the audio data, the CPU creates proxy data composed of data obtained by decreasing the resolution of the source data and of data obtained by reducing the amount of the audio data. The CPU supplies the proxy data to the temporary storage memory I/F 53.

The CPU sends the audio data of the source data or the proxy data supplied by the temporary storage memory I/F 53, to the audio output I/F 56 via the system bus 63. Further, the CPU synthesizes pieces of video data in the source data and the proxy data and supplies the resultant synthesized data to the video display I/F 58 via the system bus 63. The RAM stores a program, data, or the like to be executed by the CPU according to need.

The temporary storage memory I/F 53 is connected to a temporary storage memory 64 such as a buffer. The temporary storage memory I/F 53 stores source data composed of video data supplied from the video input interface I/F 50 and of audio data supplied from the audio input I/F 51 in a source area 71 in the temporary storage memory 64. The temporary storage memory I/F 53 also stores proxy data supplied from the microcomputer 52 in a proxy area 72 in the temporary storage memory 64.

In addition, the temporary storage memory I/F 53 reads the source data composed of the video data supplied from the video input interface I/F 50 and of the audio data supplied from the audio input I/F 51, which is stored in the source area 71 of the temporary storage memory 64 and the proxy data supplied from the microcomputer 52, which is stored in the proxy area 72 of the temporary storage memory 64. The temporary storage memory I/F 53 supplies the read source data and proxy data to the optical disc drive I/F 54 via the system bus.

Further, the temporary storage memory I/F 53 stores source data in a clip (described below) supplied from the optical disc drive I/F 54 in the source area 71 of the temporary storage memory 64 and stores proxy data corresponding to the clip in the proxy area 72 of the temporary storage memory 64. The temporary storage memory I/F 53 sends the microcomputer 52 the source data or the proxy data, which is received from the optical disc drive I/F 54 and stored in the source area 71 or the proxy area 72, respectively.

Note that a clip refers to a set of data such as video data, audio data and metadata corresponding to the video data that are obtained by using an image capturing sequence (image capturing processing from the start of image capturing to the end of the image capturing).

The optical disc drive I/F 54 is connected to an optical disc drive 65 in which an optical disc 43 is mounted. The optical disc drive I/F 54 controls the optical disc drive 65 to read a clip and proxy data corresponding to the clip and supplies the read data to the temporary storage memory I/F 53 via the system bus 63. In addition, the optical disc drive I/F 54 controls the optical disc drive 65 to record source data, proxy data, or the like from the temporary storage memory I/F 53 on the optical disc 43 in units of clips.

The operation I/F 55 is connected to an external operation device 44 including an operation button, a keyboard, a mouse, and a receiver receiving instructions transmitted from a remote controller. In response to an operation performed by a user on the operation device 44, the operation I/F 55 generates an operation signal representing the operation and supplies the operation signal to the microcomputer 52 via the system bus 63. The operation I/F 55 also turns off a light-emitting device such as a LED (light-emitting diode) mounted inside the operation unit 44.

Then, the audio output I/F 56 is connected to an external speaker 45. The audio output I/F 56 performs D/A conversion on audio data supplied by the microcomputer 52 and amplifies resultant analog signals to be supplied to the speaker 45. The speaker 45 transmits sound on the basis of the analog signals supplied by the audio output I/F 56. The audio output I/F 56 may also supply audio data to the speaker 45 without conversion processing so that the speaker 45 processes the audio data with D/A conversion or the like and outputs sound on the basis of resultant analog signals.

The serial data I/F 57 sends and receives data to and from an external digital device such as a computer (not shown) according to need. The video display I/F 58 is connected to an external display device 46. The video display I/F 58 performs D/A conversion on video data supplied by the video input interface I/F 50 and synthesized data supplied by the microcomputer 52 and amplifies resultant analog signals such as composite signals and component signals to be supplied to the display device 46. The display device 46 displays a video image on the basis of the analog signals received from the video display I/F 58.

For example, when the synthesized data is supplied from the microcomputer 52, the display device 46 may simultaneously display a video image of audio/video source material (source video) corresponding to the source data and proxy video corresponding to the proxy data. The display device 46 may also display the source video and the proxy video in conjunction with corresponding time codes.

It is also possible that the video display I/F 58 supplies source data to the display device 46 without conversion processing or the like so that the display device 46 performs D/A conversion or the like to the source data and outputs video on the basis of resultant analog signals.

The memory card I/F 59 writes and reads data such as source data and various setting data to and from a memory card (not shown) mounted in the optical disc apparatus 10 according to need. The network I/F 60 sends and receives data to and from another apparatus to which the network I/F 60 is connected via a wireless or wired network such as the Internet and a local area network (LAN) according to need.

For example, the network I/F 60 acquires a program from an external apparatus via a network and stores the program to a hard disk 67 via the system bus 63, the hard disk drive I/F 61, and the hard disk drive 66.

The hard disk drive I/F 61 is connected to the hard disk drive 66 in which the hard disk 67 is mounted. The hard disk drive I/F 61 controls the hard disk drive 66 to write and read data to and from the hard disk 67. For example, the hard disk drive I/F 61 controls the hard disk drive 66 so as to store a program received via the network I/F 60 and the system bus 63 in the hard disk 67.

The drive I/F 62 is connected to a drive 68. The drive I/F 62 controls the drive 68 to drive a removal medium 47 to be mounted therein, such as a magnetic disk, an optical disc, an magneto-optical disc, and a semiconductor memory and acquire a program and data stored in the removal medium 47. The acquired program and data are transferred to the hard disk 67 for storage via the hard disk drive I/F 61 or the like according to need.

The system bus 63 intermediates data transmission between the individual components interconnected therethrough.

In the optical disc apparatus 10 in FIG. 1, the microcomputer 52 serves as an editing processor configured to perform nonlinear editing on source data by executing a predetermined program.

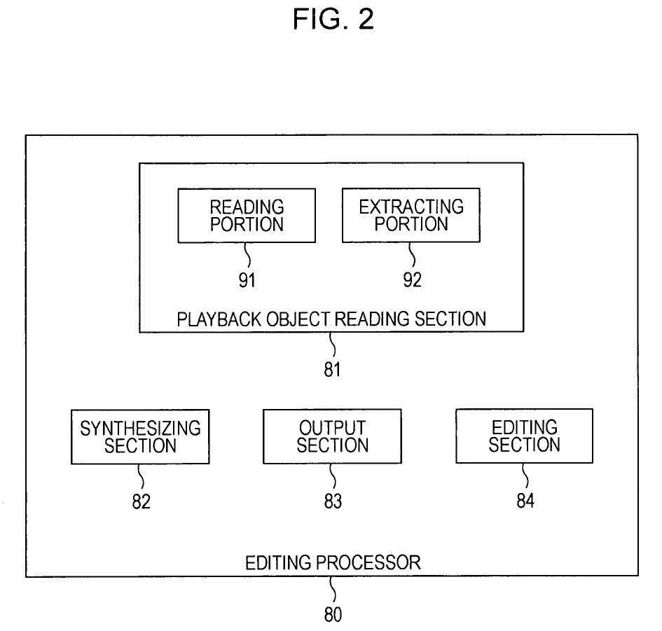

FIG. 2 illustrates a functional configuration of such an editing processor according to an embodiment of the present invention.

In FIG. 2, an editing processor 80 includes a playback object reading section 81, a synthesizing section 82, an output section 83, and an editing section 84. These sections are capable of sending and receiving data among them according to need.

The playback object reading section 81 includes a reading portion 91 and an extracting portion 92.

The reading portion 91 controls the optical disc drive I/F 54 in accordance with an operation signal supplied from the operation unit I/F 55 to read an edit list representing a result of editing of a clip, from the optical disc 43 mounted in the optical disc drive 65 and supply the read edit list to the editing section 84. The reading portion 91 also controls the optical disc drive I/F 54 to read proxy data, source data attached with proxy data, or the like from the optical disc 43 and supplies the read data to the extracting portion 92.

The extracting portion 92 controls the temporary storage memory I/F 53 to stores proxy data supplied by the reading portion 91 in the proxy area 72 of the temporary storage memory 64. The extracting portion 92 also extracts the source data from the source data with the proxy data supplied by the reading portion 91. The extracting portion 92 controls the temporary storage memory I/F 53 to store the extracted source data in the source area 71 of the temporary storage memory 64.

The synthesizing unit 82 controls the temporary storage memory I/F 53 in accordance with an operation signal supplied from the operation unit I/F 55 to read video data in the source data stored in the source area 71 of the temporary storage memory 64 and video data in the proxy data stored in the proxy area 72 of the temporary storage memory 64. The synthesizing unit 82 synthesizes the read pieces of video data so that a video image of the audio/video source material (hereinafter referred to as source video) and proxy video are displayed simultaneously on the display device 46. At this time, the source video is displayed in one of two screens provided in the display area of the display device 46 and the proxy video is displayed on the other one of the screens.

The synthesizing unit 82 supplies the synthesized data obtained as a result of the above synthesis process to the video display I/F 58. As a result, the source video and the proxy video are displayed on the individual screens provided in the display area of the display device 46. Hereinafter, among these two screens provided in the display area of the display device 46, one which is larger than the other is referred to as a parent screen and the other which is smaller than the parent screen is referred to as a child screen.

The output section 83 controls the temporary storage memory I/F 53 in accordance with an operation signal received from the operation unit I/F 55 to read the audio data in the source data stored in the source area 71 of the temporary storage memory 64 or audio data in the proxy data stored in the proxy area 72 of the temporary storage memory 64. The output section 83 also supplies the read audio data to the audio output I/F 56 so that sound corresponding to the audio data is output from the speaker 45.

The editing section 84 creates an edit list on the basis of an operation signal supplied from the operation unit I/F 55. The editing section 84 controls the optical disc drive I/F 54 to record the created edit list on the optical disc 43.

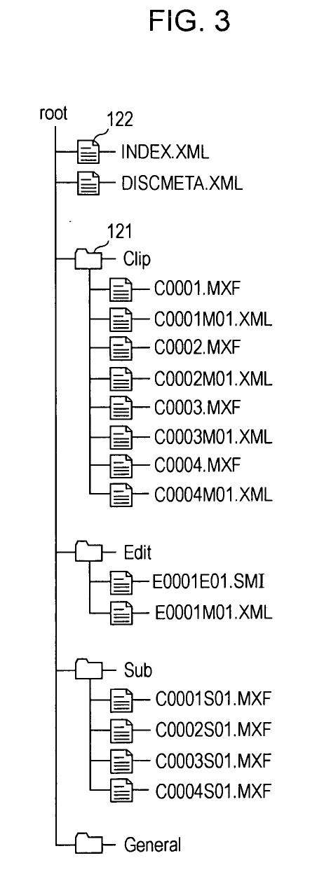

FIG. 3 illustrates an example of a directory structure of files stored in the optical disc 43.

In FIG. 3, a symbol 121 indicates one directory. Although not designated by a reference number, every symbol in FIG. 3 that is identical to the symbol (directory) 121 indicates one directory. A symbol 122 indicates a file. Although not designated by a reference number, every symbol in FIG. 3 that is identical to the symbol (file) 122 indicates one file.

In the following description, a directory also refers to a corresponding directory symbol unless specifically stated otherwise. Similarly, a file also refers to a corresponding file symbol unless specifically stated otherwise. In addition, to facilitate identification of individual directories and files, the names of the files and directories are indicated in parentheses.

In the example of FIG. 3, the optical disc 43 has an index file (INDEX.XML) 122 which serves as a data file storing an index and information for managing clips and an edit list and a disc metafile (DISCMETA.XML) which serves as a data file for disc metadata composed of data such as a path to representative image data of the optical disc 43, a title of the optical disc 43 and a comment.

The optical disc 43 is also provided with a clip directory (Clip) 121 under which files of source data or the like in clips are stored, an edit list directory (Edit) under which files of an edit list are stored, and a proxy directory (Sub) under which files of proxy data are stored.

The clip directory (Clip) 121 stores source data, metadata, or the like in clips recorded on the optical disc 43 as different files which belong to the individual clips.

Specifically, in the example of FIG. 3, data of four clips is stored in the optical disc 43.

For example, under the clip directory 121, a first clip file (C0001.MXF) for source data of a clip first recorded on the optical disc 43 (first clip), and a first non-real-time metadata file (C0001M01.XML) containing metadata corresponding to the source data of the first clip, on which real time processing is not requested (hereinafter referred to as non-real-time metadata) are stored.

In addition, under the clip directory 121, a second clip file (C0002.MXF), a second non-real-time metadata file (C0002M01.XML), a third clip file (C0003.MXF), a third non-real-time metadata file (C0003M01.XML), a fourth clip file (C0004.MXF), and a fourth non-real-time metadata file (C0004M01.XML) are stored, in a similar manner to the first clip file (C0001.MXF) and the first non-real-time metadata file (C0001M01.XML).

In FIG. 3, the edit directory (Edit) shown below the clip directory 121 stores an edit list recorded on the optical disc 43 as files based on editing processes.

For example, in FIG. 3, under the edit directory (Edit), an edit list file (E0001E01.SMI) containing an edit list representing a result of a first editing process performed on a clip recorded on the optical disc 43 and an edit list metadata file (E0001M01.XML) containing metadata corresponding to source data in every editing section constituting edited data which is the result of the first editing process or metadata newly created on the basis of the metadata are stored.

In FIG. 3, a proxy directory (Sub) shown below the edit directory (Edit) stores proxy data of clips stored in the optical disc 43 as different files which belong to the individual clips.

In the example of FIG. 3, under the proxy directory (Sub), a first proxy file (C0001S01.MXF) which is a file for proxy data of the clip first stored in the optical disc 43, a second proxy file (C0002S01.MXF) which is a file for proxy data of the clip secondly stored in the optical disc 43, a third proxy file (C0003S01.MXF) which is a file for proxy data of the clip thirdly stored in the optical disc 43, and a fourth proxy file (C0004S01.MXF) which is a file for proxy data of the clip fourthly stored in the optical disc 43.

Further, the optical disc 43 stores a general directory (General) storing a file for data other than the clips, edit list, and proxy data.

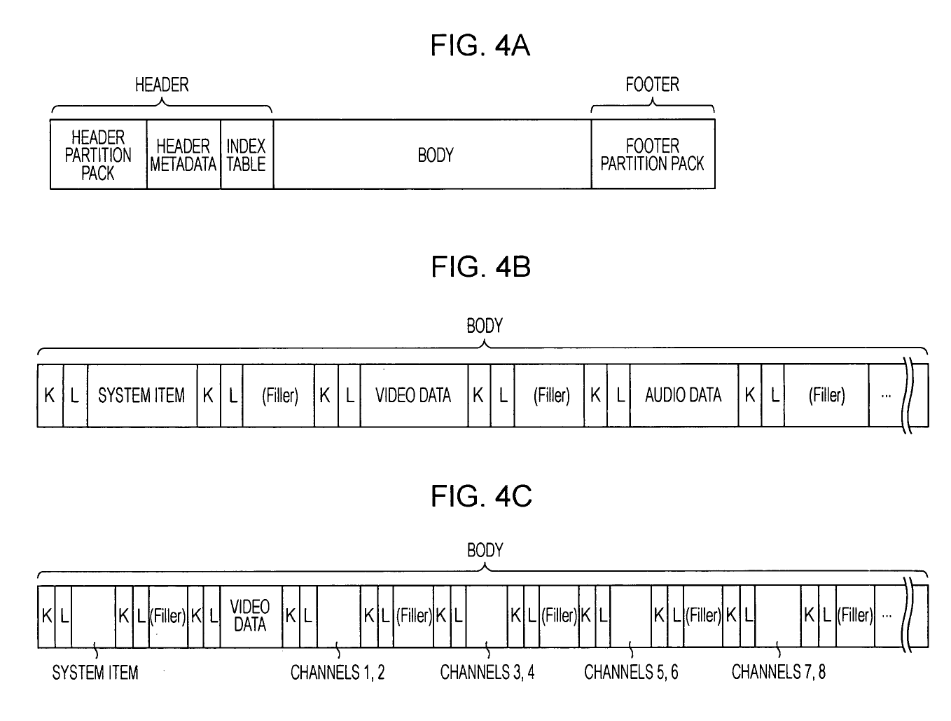

FIGS. 4A to 4C illustrate examples of formats of a clip file and a proxy file illustrated in FIG. 3. As illustrated in FIG. 4A, each clip file or proxy file includes a body in which source data or proxy data for one clip is stored and a header and a footer attached to the body.

The header contains a header partition pack, header metadata, and an index table in that order from the beginning of the header. The header partition pack contains partition metadata representing a file format (e.g., Material exchange Format (MXF)), the length of the body, a beginning position of the body, data indicating the format of data contained in the body, or the like. The header metadata contains, for example, a unique material identifier (UMID), a start time code, a date of file creation, and information on data contained in the body (e.g., the number of pixels in video, an aspect ratio, etc.).

A UMID is an identifier specific to a clip for globally uniquely identifying the clip and is defined by SMPTE (Society of Motion Picture and Television Engineers).

The index table contains data for managing data stored in the body. The footer is composed of a footer partition pack containing data for identifying the footer.

As illustrated in FIG. 4B, the body of a clip file contains a system item in which metadata for one frame, on which real time processing may be requested (hereinafter referred to as real time metadata), video data encoded by an MPEG (Moving Picture Experts Group) IMX system called D10, and non-compressed audio data in AES (Audio Engineering Society)3 format, which are KLV (Key, Length, Value)-coded so as to have KLV structures.

The KLV structure means a structure in which Key, Length, and Value are sequentially arranged. Key includes a label of 16 bytes. The label complies with an SMPTE 298M standard and indicates what data is contained in Value. Length contains the length of data contained in Value. Value contains actual data (i.e., the system item, the video data, or the audio data in this case).

Each of the KLV-coded system item, video data, and audio data has a fixed length based on KAG (KAV alignment grid). A filler having a KLV structure is provided subsequent to each of the KLV-coded system item, video data, and audio data to serve as stuffing allowing each data to have a fixed data length.

As illustrated in FIG. 4C, the body of a proxy file includes a system item in which time codes of all frames constituting source data for a predetermined playback time period is contained, MPEG4-compressed video data, and G.711-encoded audio data. Each of the system item, video data, and audio data is also KLV-coded to have a KLV structure.

The audio data is composed of 8-channel audio data which is divided so as to be stored in units of two channels. Specifically, in the body of the proxy file, the G711-encoded audio data is divided into G.711-encoded audio data of channel 1 and channel 2, G.711-encoded audio data of channel 3 and channel 4, G.711-encoded audio data of channel 5 and channel 6, and G.711-encoded audio data of channel 7 and channel 8.

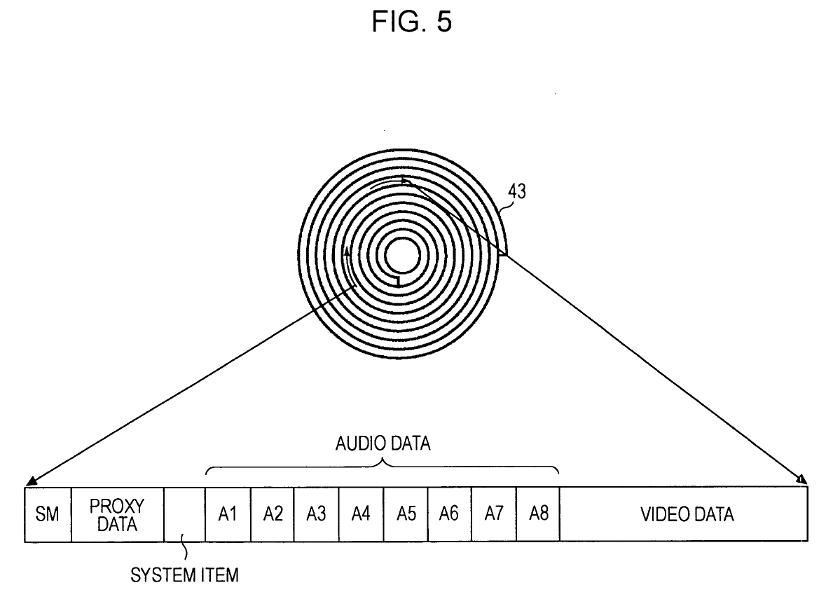

Now, referring to FIG. 5, a recording position of data for a clip file and a proxy file on the optical disc 43 will be described.

As illustrated in FIG. 5, video data and audio data for one clip located in the body of the clip file, proxy data located in the body of the proxy data, system items located in the bodies of clip file and the proxy file are each divided to form a unit of annular regions each corresponding to a predetermined playback time slot (for example, 2 seconds). The divided annular data is interleaved so as to be recorded on the track of the optical disc 43.

In playback of video and audio, both video data and corresponding audio data are necessary. Thus, it is desirable to record video data and audio data in the same time slot at positions close to each other (e.g., adjacent positions) on the optical disc 43.

Therefore, on the track of the optical disc 43, data sets in each of which proxy data in an annular region (hereinafter referred to as annular proxy data), a system item in an annular region (hereinafter referred to as an annular system item), audio data in an annular region (hereinafter referred to as annular audio data), and video data in an annular region (hereinafter referred to as annular video data), which are to be played back in the same playback time slot are sequentially arranged, are sequentially recorded from the earliest playback time slot to the latest on the track of the optical disc 43.

Thus, the annular proxy data, annular system item, annular audio data, and annular video data are located on the track of the optical disc 43 as a data set. Thus, to read the annular video data and the annular audio data, it is necessary to also read annular proxy data and the annular system item located preceding the annular video data and the annular audio data. On the other hand, the annular proxy data can be read alone since it is located at a leading portion of the set.

In addition, a salvage marker is attached to the set. The salvage marker is used for data recovery in the case of abnormal termination of a file.

When recording of the set for one clip with the salvage marker attached thereto on the optical disc 43 is completed, recording of a footer and a header on the optical disc 43 is performed.

Note that the sizes of annular regions corresponding to the annular video data and the annular audio data may be the same or different from each other.

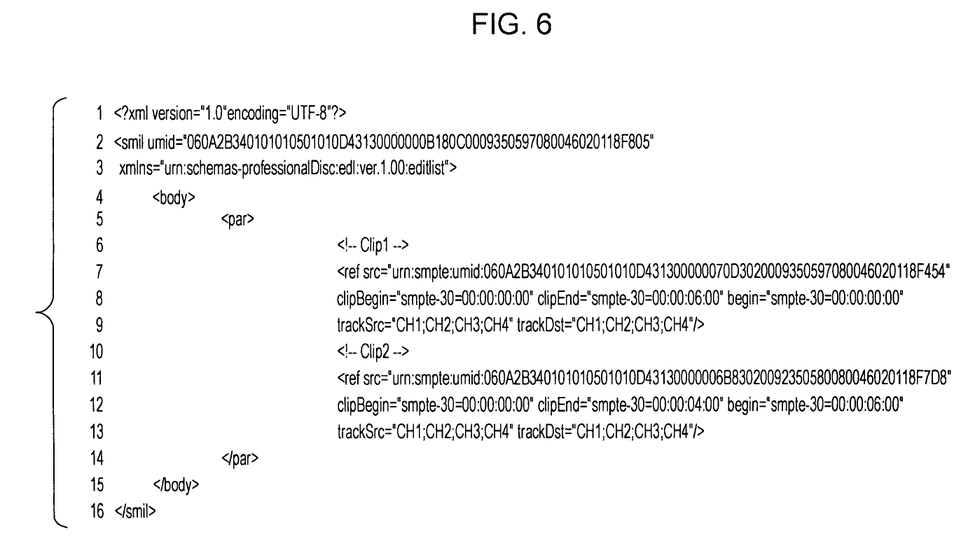

FIG. 6 illustrates an example of an edit list in the edit list file in FIG. 3.

Specifically, FIG. 6 illustrates an example of a detailed file description of the edit list file described in XML (eXtensible Markup Language). In FIG. 6, a number indicated at the beginning of each row is used for ease of the following description, and is not included in the XML description.

The edit list file contains an edit list which is information representing a result of editing of a clip. The edit list file also contains a playback scheme of resultant edited data.

As illustrated in FIG. 6, the XML description of the edit list file is primarily composed of a body portion indicated by a pair of “body” tags (<body></body>). In the example of FIG. 6, this body portion is described in rows 4 to 15. Note that the description in rows 1 to 3 indicates that the file is an edit list on a professional disc.

In the body portion, information relating to time-varying behavior of editing description. In the example of FIG. 6, a “par” element described between an open tag “<par>” and a corresponding close tag “</par>” is a time container that defines a simple time group for simultaneous playback of a plurality of elements. In the example of FIG. 6, the first clip, which is described as “Clip 1” and corresponds to the first clip file (C0001.MXF) in FIG. 3, for example, and the second clip, which is described as “Clip 2” and corresponds to the second clip file (C0002.MXF) in FIG. 3, are to be played back simultaneously.

However, it can be seen from the description in FIG. 6 that the playback start times of the two clips are different from each other, and the two clips are actually to be played back consecutively, which will be described below.

In FIG. 6, in a “ref” element described in rows 7 through 9, information such as a file to be referred to and a playback range of the file to be refereed to is described. “src=”urn:smpte:umid:060A2B340101010501010D431300000070D3020 009350597080046020118F454” written in row 7 indicates that the value of the UMID assigned to the file to be referred to is “060A2B340101010501010D431300000070D302000935059708004602011 8F454”.

In addition, “clipBegin=“smpte-30=00:00:00:00” written in row 8 indicates a position at which playback of the first clip is started (i.e., in-point) in an FTC (file time code) of the first clip, and the unit is the number of frames. This FTC is relative position information sequentially allocated to individual frames of each file, in which the first frame number of each file is set to “0”. Similarly, “clipEnd=“smpte-30=00:00:06:00”” written in row 8 indicates a position at which the playback of the first clip is to be stopped (i.e., out-point) in the FTC of the first clip.

Further, “begin=“smpte-30=00:00:00:00” ” written in row 8 indicates a time point at which the first clip begins, i.e., a position at which source data in an editing section begins in the FTC in the edit list, and the unit is the number of frames. In addition, “smpte-30” indicates that a time code to be used is an SMPTE time code at 30 frames per second which is defined by SMPTE.

Moreover, “trackSrk=“CH1;CH2;CH3;CH4”” written in row 9 indicates channels corresponding to audio data to be played back (hereinafter referred to as playback channels) among audio data of channel 1 to channel 8 contained in the first clip. “trackDst=“CH1;CH2;CH3;CH4”” written in row 9 indicates which channels are used for output of the audio data of the playback channels, i.e., a channel through which audio data of each playback channel is output (hereinafter referred to as output channels).

As described above, in the example of FIG. 6, the edit list describes that the playback of the first clip starts at the time “00:00:00:00” from the position of the frame number “00:00:00:00” and the playback is continued up to the position of the frame number “00:00:06:00”. At this time, the audio data of channel 1 to channel 4 among the audio data of channel 1 to channel 8 is played back as audio data output through channel 1 to channel 4, respectively.

The second clip is described similarly to the first clip in row 11 through row 13. In the example of FIG. 6, the edit list describes that the playback of the second clip starts at the time “00:00:06:00” from the position of the frame number “00:00:00:00” and is continued up to the position of the frame number “00:00:04:00”. Also in this case, the audio data of channel 1 to channel 4 among the audio data of channel 1 to channel 8 is played back as audio data output through channel 1 to channel 4, respectively.

In the edit list illustrated in FIG. 6, the “per” element specifies that the first clip and the second clip be played back simultaneously, as described above. As a result, the first clip is played back from the position of the frame number “00:00:00:00” to the position of the frame number “00:00:06:00”. Then, when the time “00:00:06:00” comes, the second clip is played back from the position of the frame number “00:00:00:00” to the position of the frame number “00:00:04:00”. As described above, the edit list shown in FIG. 6 indicates that editing is performed so that the first clip and the second clip will be played back consecutively.

In other words, the edit list illustrated in FIG. 6 specifies that after the first clip (Clip 1) is played back for six seconds the second clip (Clip 2) is played back for four seconds.

While an example of an UMID representing each data is shown in FIG. 6, this simply indicates a description position or the like of the UMID in the edit list and serves as a virtual UMID with a meaningless value. That is, the UMID shown in FIG. 6 is composed of meaningless symbols and is different from an actual UMID. In practice, a valid UMID created on the basis of a method defined by SMPTE is written in each description position in place of the virtual UMID.

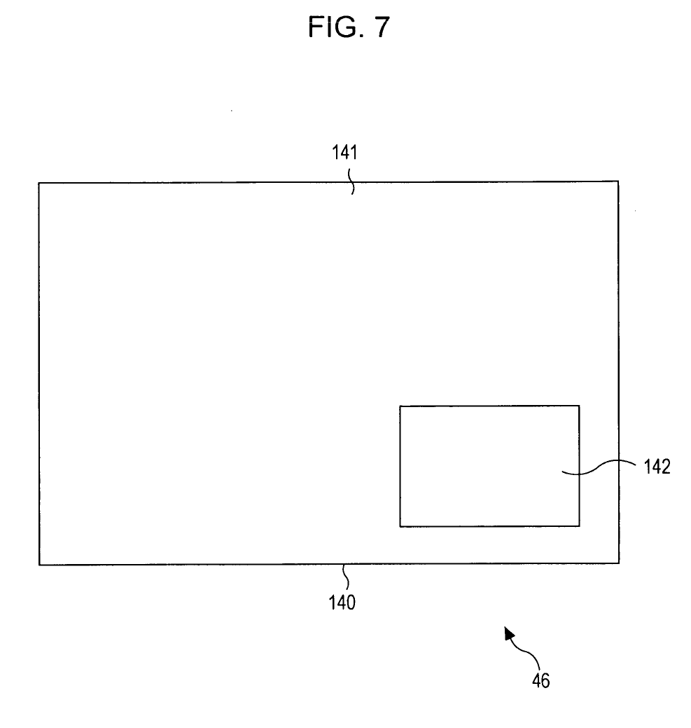

Now, referring to FIG. 7, a parent screen and a child screen provided in a display area 140 of the display device 46 will be described.

In FIG. 7, a parent screen 141 is provided over the entire display area 140 of the display device 46, and a child screen 142 is provided at a lower right portion of the parent screen 141. Source video is displayed in the parent screen 141 and proxy video is displayed in the child screen 142.

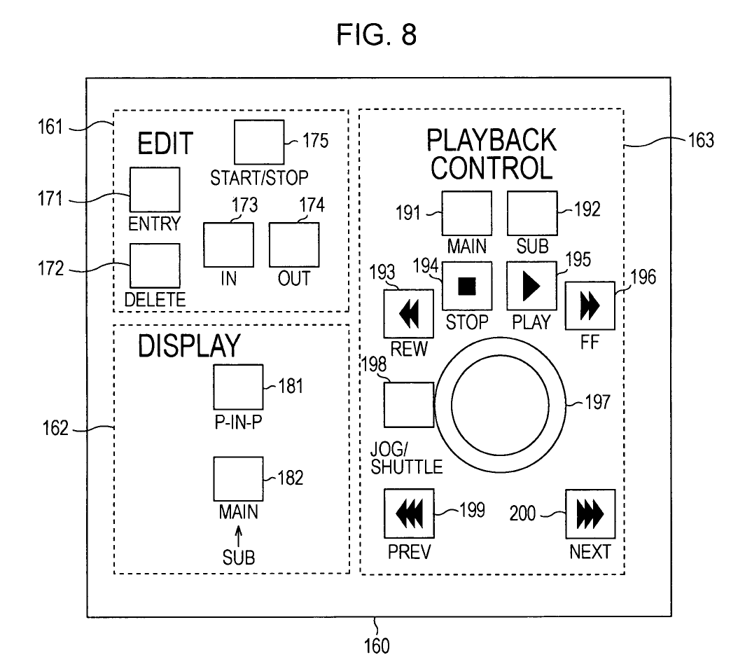

FIG. 8 illustrates an operation surface of an editing operation part 160 provided in the operation unit 44 in FIG. 1, for receiving a user operation relating to editing.

On the upper surface of the editing operation part 160 in FIG. 8, an edit section 161, a display section 162, and a control section 163 are provided. The edit section 161, placed at an upper left portion in the editing operation part 160, is provided with operation buttons for receiving operations related to the creation of an edit list. The display section 162, placed at a lower left portion of the editing operation part 160, is provided with operation buttons for receiving an operation related to display. The control section 163, placed at a right portion of the editing operation part 160, is provided with operation buttons for receiving operation related to playback.

In the edit section 161, an entry button (ENTRY) 171, a delete button (DELETE) 172, an in-point button (IN) 173, an out-point button (OUT) 174, and a start/stop button (START/STOP) 175 are arranged.

The ENTRY button 171 is pressed together with the IN button 173 when the FTC of source video displayed in the parent screen 141 or the FTC of proxy video displayed in the child screen 142 is to be set as an in-point. The ENTRY button 171 is pressed together with the OUT button 174 when the FTC of source video displayed in the parent screen 141 or the FTC of proxy video displayed in the child screen 142 is to be set as an out-point.

The DELETE button 172 is pressed together with the IN button 173 when a description of an in-point around the FTC of a playback control object described below is to be deleted. The DELETE button 172 is pressed together with the OUT button 174 when a description of an out-point around the FTC of a playback control object described below is to be deleted. The START/STOP button 175 is pressed when editing processing is to be started or stopped.

In the display section 162, a picture-in-picture button (P-IN-P) 181 and a sub-main button (SUBMAIN) 182 are arranged.

The P-IN-P button 181 is pressed when a picture-in-picture display is started or stopped. A picture-in-picture display refers to a simultaneous display of the parent screen 141 and the child screen 142. The sub-main button 182 is pressed when display of a source video corresponding to an FTC identical to the FTC of a proxy video being displayed in the child screen 142 is instructed.

In the playback control section 163, a main button (MAIN) 191, a sub button (SUB) 192, a rewind button (REW) 193, a stop button (STOP) 194, a playback button (PLAY) 195, a fast forward button (FF) 196, a dial 197, a jog-shuttle mode button (JOG/SHUTTLE) 198, a previous button (PREV) 199, and a next button (NEXT) 200 are arranged.

The MAIN button 191 is pressed when source data corresponding to source video displayed in the parent screen 141 is set as an object to be processed in accordance with an operation on the REW button 193, the STOP button 194, the PLAY button 195, the FF button 196, the dial 197, the JOG/SHUTTLE button 198, the PREV button 199, or the NEXT button 200 (hereinafter correctively referred to as playback control buttons). Such an object to be processed in accordance with an operation on any of these playback control buttons is hereinafter referred to as a playback control object.

The SUB button 192 is pressed when the proxy data corresponding to proxy video displayed in the child screen 142 is set as a playback control object. Each of the MAIN button 191 and the SUB button 192 is provided therein with a light-emitting device (not shown) such as a LED (light-emitting diode). The light-emitting device emits light when the corresponding MAIN button 191 or SUB button 192 is pressed.

The REW button 193 is pressed when rewind playback of a playback control object is to be performed. The STOP button 194 is pressed when playback of a playback control object is to be stopped. The PLAY button 195 is pressed when a playback control object is played back at 1× speed. The FF button 196 is pressed when fast forward playback of a playback control object is performed.

The dial 197 is rotated in the circumferential direction when a playback point of a playback control object is changed. For example, a user instructs a change of playback point to a forward position by rotating the dial 197 clockwise in the circumferential direction and instructs a change of the playback point to a backward position by rotating the dial 197 counterclockwise in the circumferential direction.

The JOG/SHUTTLE button 198 is pressed when the mode of the dial 197 is set to a jog mode or a shuttle mode. When the dial 197 is in the jog mode, the playback point is changed in accordance with the movement of the dial 197. When the dial 197 is in the shuttle mode, the playback speed is changed in accordance with the movement of the dial 197.

The PREV button 199 is pressed when the playback point is changed to the FTC of the beginning of the clip immediately preceding a clip corresponding to the playback control object. The NEXT button 200 is pressed when the playback point is changed to the FTC of the beginning of the clip immediately succeeding the clip corresponding to the playback control object.

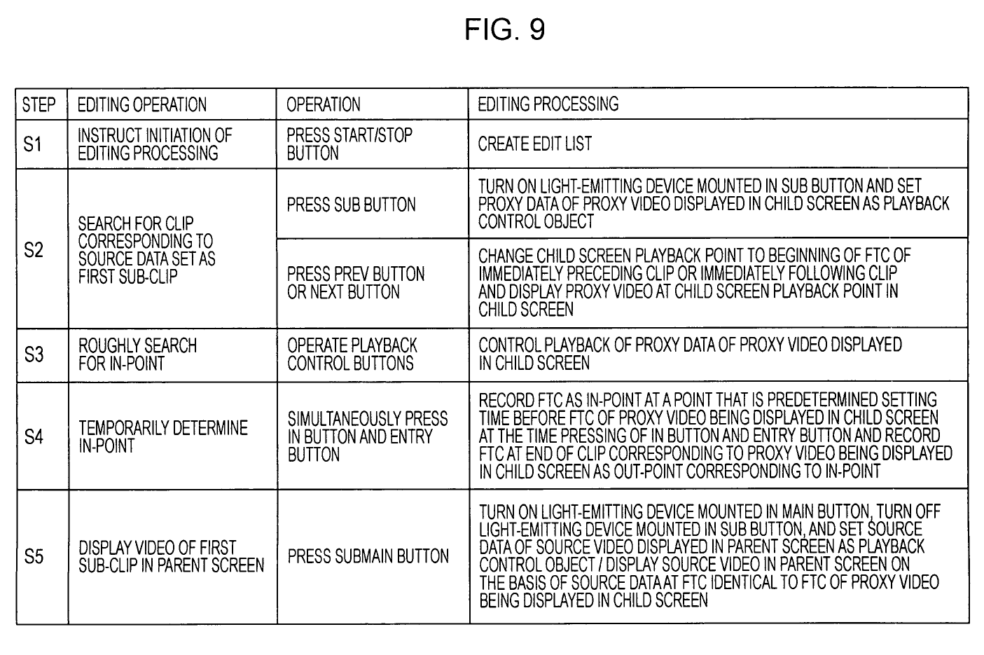

Now, referring to FIGS. 9 to 11, editing operation performed by a user using the editing operation part 160 will be described.

In each of tables shown in FIGS. 9 to 11, numbers designated to individual steps of editing operations and corresponding content of editing operations, operations performed on the editing operation part 160, and processing performed by the optical disc apparatus 10 are described.

As illustrated in FIG. 9, at Step S1, the user presses the START/STOP button 175 to instruct the start of editing processing. At this time, the optical disc apparatus 10 creates an edit list.

At Step S2, the user searches for a clip corresponding to source data which is to be set as a first sub-clip. A sub-clip is referred to as clip-based source data in an editing section.

Specifically, in Step S2, the user first presses the SUB button 192. At this time, the optical disc apparatus 10 turns on the light-emitting device mounted in the SUB button 192, so that proxy data corresponding to proxy video displayed in the child screen 142 is set as a playback control object.

Then, the user presses the PREV button 199 or the NEXT button 200 until proxy video at the beginning of the clip corresponding to the source data set as the first sub-clip is displayed in the child screen 142.

Specifically, when the user presses the PREV button 199 or the NEXT button 200, the optical disc apparatus 10 changes the playback point of proxy video displayed in the child screen 142 (hereinafter referred to as a child screen playback point) to the FTC of the beginning of the immediately preceding clip or the immediately following clip, and displays the proxy video at the child screen playback point in the child screen 142. Thus, the user can change the child screen playback point to the FTC of the beginning of a desired clip by pressing the PREV button 199 or the NEXT button 200 while viewing the proxy video displayed in the child screen 142. As a result, the proxy video at the beginning of the clip corresponding to the source data set as the first sub-clip is displayed.

At Step S3, the user roughly searches for an in-point by operating the playback control buttons.

Specifically, when the user operates the playback control buttons, the optical disc apparatus 10 controls playback of the playback control object (the proxy data corresponding to proxy video displayed in the child screen 142 in this case) in accordance with the user operation. The optical disc apparatus 10 changes the child screen playback point in response to the operation on the playback control buttons. Thus, the user specifies a desired FTC as the child screen playback point by operating the playback control buttons and changes the child screen playback point to the specified FTC, so that the proxy video corresponding to an FTC roughly set as an in-point is displayed in the child screen 142.

At Step S4, the user temporarily determines the in-point by simultaneously pressing the IN button 173 and the ENTRY button 171. At this time, the optical disc apparatus 10 records in the edit list an FTC as the in-point at a point that is a predetermined setting time before the FTC of the proxy video being displayed in the child screen 142 at the time of the pressing of the IN button 173 and the ENTRY button 171. The optical disc apparatus 10 also records in the edit list an FTC at the end of the clip corresponding to the proxy video being displayed in the child screen 142 as the out-point corresponding to the in-point.

The above setting time may be set by the user, for example. Specifically, the user first presses a menu button (not shown) provided on the editing operation part 160 to display a setting screen for setting the setting time on the display device 46. Then, the user moves an indicator to select a digit of a number representing a time indicated in the setting screen from a higher order to a lower order digit or vice versa to specify a digit of the number to be changed, by operating the PREV button 199 or the NEXT button 200 while viewing the time indicated in the setting screen. The user then operates the dial 197 to change the number of the digit. The user repeats the movement of the indicator and changes the numbers until a desired time is indicated in the setting screen. Once the desired time is indicated in the setting screen, the user presses the menu button again so as to set the time currently indicated in the setting screen as the setting time.

At Step S5, the user presses the SUBMAIN button 182 so that video corresponding to the first sub-clip is displayed in the parent screen 141. At this time, the optical disc apparatus 10 turns on the light-emitting device mounted in the MAIN button 191 and turns off the light-emitting device mounted in the SUB button 192. This indicates that the source data of the source video displayed in the parent screen 141 is set as the playback control object.

In addition, the optical disc apparatus 10 sets an FTC that is identical to the FTC of the proxy video being displayed in the child screen 142 as the playback point of the source video displayed in the parent screen 141 (hereinafter referred to as a parent screen playback point) and displays the source video in the parent screen 141 on the basis of the source data at the parent screen playback point. As a result, the source video of a frame identical to the frame of the proxy video displayed in the child screen 142 is displayed in the parent screen 141.

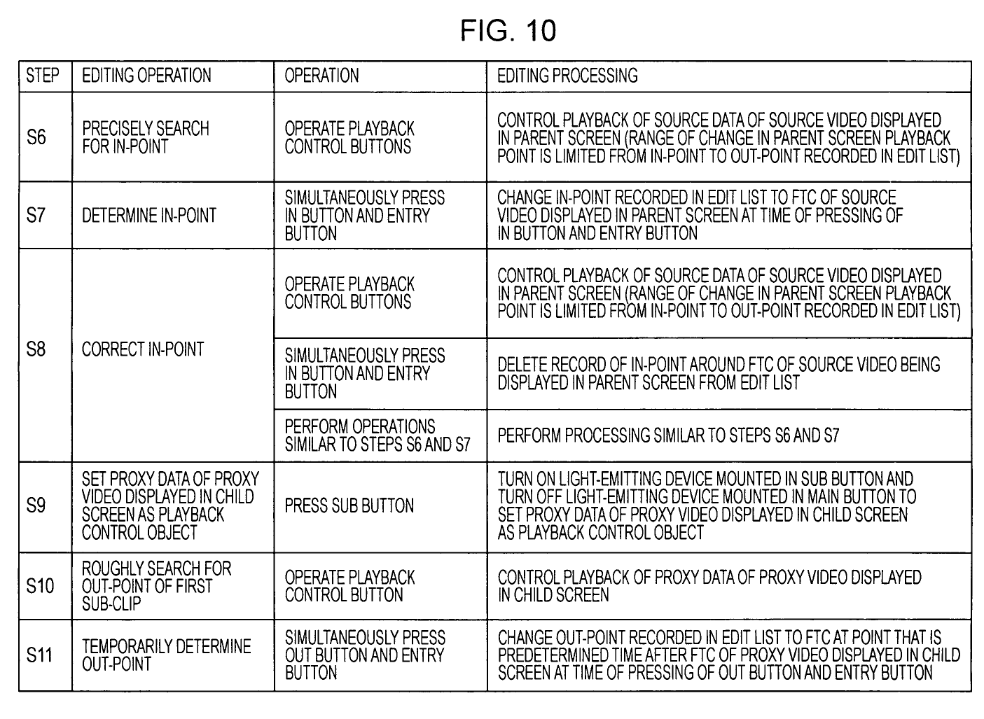

Referring to FIG. 10, at Step S6, the user precisely searches for the in-point by operating the playback control buttons. When the user operates the playback control buttons, the optical disc apparatus 10 controls playback of the playback control object (source data of the source video displayed in the parent screen 141 in this case) in accordance with the operation. That is, the optical disc apparatus 10 changes the parent screen playback point in response to operations on the playback control buttons.

Thus, the user specifies a desired FTC as the parent screen playback point by operating the playback control buttons and changes the parent screen playback point to the specified FTC, so that the source video corresponding to the FTC that is precisely set as the in-point is displayed in the parent screen 141. At this time, the range within which the parent screen playback point is changed is limited from the in-point to the out-point that are recorded in the edit list in the processing of Step S4 (FIG. 9).

At Step S7, the user determines the in-point by simultaneously pressing the IN button 173 and the ENTRY button 171. At this time, the optical disc apparatus 10 changes the in-point recorded in the edit list in the processing of Step S4 to the FTC of the source video which is displayed in the parent screen 141 at the time of the pressing of the IN button 173 and the ENTRY button 171.

At Step S8, the user corrects the in-point as necessary. Specifically, the user first operates the playback control buttons so that the source video at an FTC around the FTC of the in-point to be corrected is displayed in the parent screen 141.

Specifically, the optical disc apparatus 10 displays in the parent screen 141 source video corresponding to an FTC at a point around the in-point to be corrected, by controlling playback of the source data of the source video displayed in the parent screen 141. At this time, a range within which the parent screen playback point is changed is limited from the in-point recorded in the edit list in the processing of Step S7 to the out-point recorded in the edit list in the processing of Step S4 in FIG. 9.

Then, the user simultaneously presses the IN button 173 and the DELETE button 172. At this time, the optical disc apparatus 10 deletes the record of the in-point around the FTC of the source video being displayed in the parent screen 141 from the edit list and records the FTC which has been recorded as the in-point in the processing of Step S4 as the in-point again. Then, the user performs operations similar to the operations performed in the processing of Step S6 and Step S7. The user repeats the operations of Step S8 until a desired in-point is recorded in the edit list.

At Step S9, the user presses the SUB button 192 to set the proxy data corresponding to the proxy video displayed in the child screen 142 as the playback control object. At this time, the optical disc apparatus 10 turns on the light-emitting device mounted in the SUB button 192 and turns off the light-emitting device mounted in the MAIN button 191.

At Step S10, the user roughly searches for an out-point by operating playback control buttons, similarly to the processing of Step S3 in FIG. 9. At Step S11, the user temporarily determines the out-point by simultaneously pressing the OUT button 174 and the ENTRY button 171. At this time, the optical disc apparatus 10 changes the out-point recorded in the edit list in the processing of Step S4 to an FTC at a point that is predetermined setting time after the FTC of the proxy video displayed in the child screen 142 at the time of the pressing of the OUT button 174 and the ENTRY button 171.

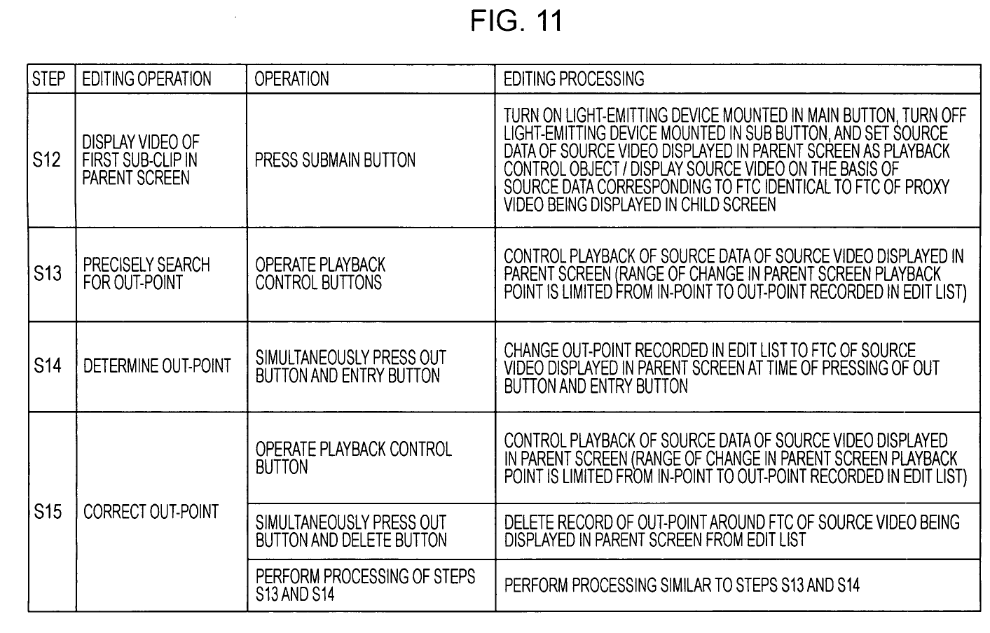

At Step S12 in FIG. 11, the user causes video corresponding to the first sub-clip in the parent screen 141 to be displayed by pressing the SUBMAIN button 182 similarly to the processing of Step S5 in FIG. 9. At Step S13, the user precisely searches for the out-point by operating the playback control buttons similarly to the processing of Step S6 in FIG. 10.

At Step S14, the user determines the out-point by simultaneously pressing the OUT button 174 and the ENTRY button 171. At this time, the optical disc apparatus changes the out-point recorded in the edit list in the processing of Step S11 (FIG. 10) to the FTC of the source video displayed in the parent screen 141 at the time of pressing of the OUT button 174 and the ENTRY button 171.

At Step S15, the user corrects the out-point as necessary. Specifically, the user first displays the source video at an FTC at a point around the out-point to be corrected in the parent screen 141 by operating the playback control buttons. At this time, a range within which the parent screen playback point is changed is limited from the in-point recorded in the edit list in the processing of Step S7 to the out-point recorded in the edit list in the processing of Step S14.

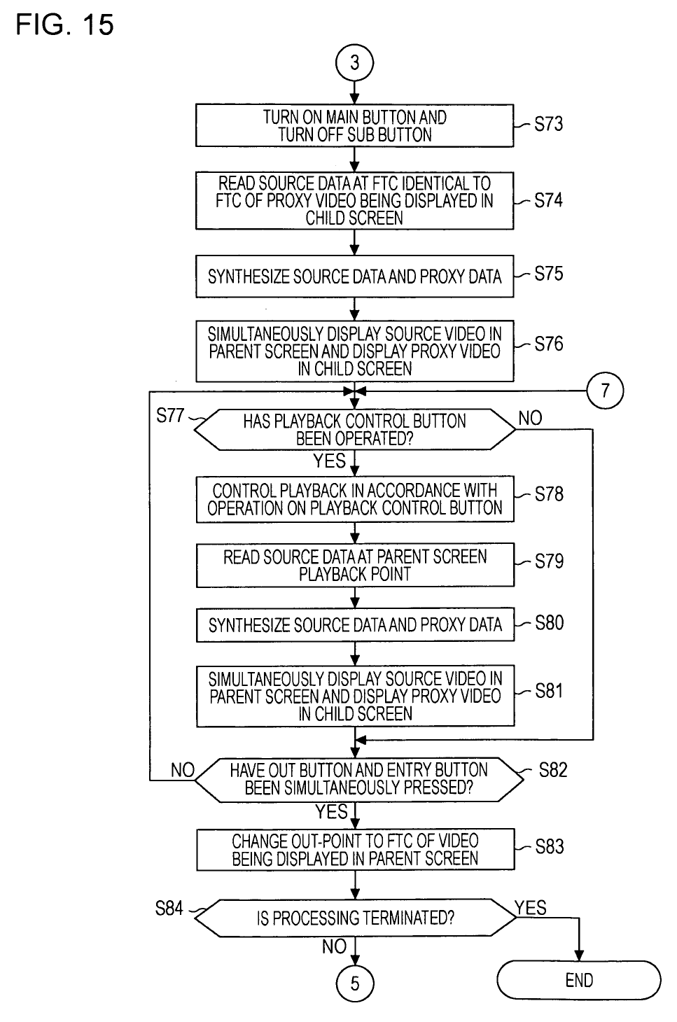

Subsequently, the user simultaneously presses the OUT button 174 and the DELETE button 172. At this time, the optical disc apparatus 10 deletes the record of the out-point around the FTC of the source video being displayed in the parent screen 141 from the edit list and records the FTC recorded as the out-point in the processing of Step S11 as the out-point again. Then, the user performs operations similar to the operations performed in the processing of Step S13 and Step S14. The user repeats the operations of FIG. 15 until a desired out-point is recorded in the edit list.

By repeating the above editing operations, the user performs nonlinear editing on source data recorded in the optical disc 43. As a result, the in-points and out-points of all sub-clips constituting the editing data are recorded in the edit list.

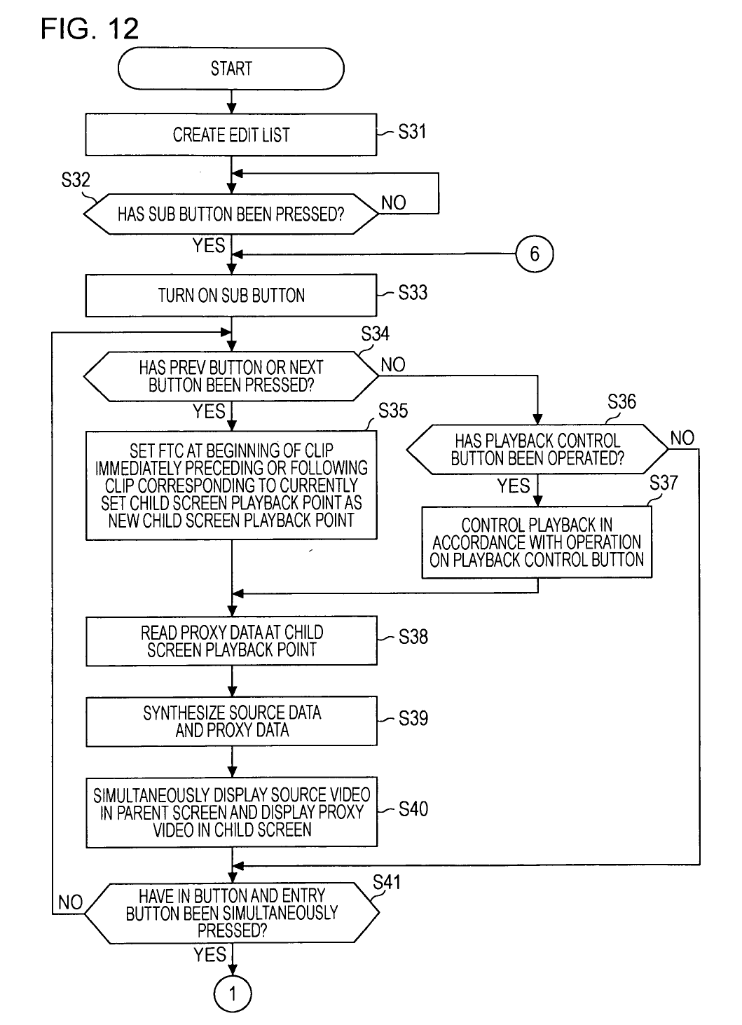

In the following, referring to FIGS. 12 to 16, a procedure of editing processing in which the optical disc apparatus 10 performs nonlinear editing on source data will be described in detail. This editing processing is initiated when, for example, a user presses the START/STOP button 175 illustrated in FIG. 8.

Note that when the editing processing is initiated, a child screen playback point and a parent screen playback point are set at predetermined positions (for example, an FTC at the beginning of the first clip).

At Step S31, the editing section 84 creates an edit list. The editing section 84 controls the optical disc drive I/F 54 to record the created edit list as an edit list file on the optical disc 43.

At Step S32, the reading portion 91 determines whether the SUB button 192 has been pressed by a user, i.e. whether an operation signal indicating a pressing of the SUB button 192 by a user has been supplied. If it is determined that the SUB button 192 has not been pressed, the reading portion 91 waits until the SUB button 192 is pressed.

On the other hand, if it is determined in Step S32 that the SUB button 192 has been pressed, the reading portion 91 controls the operation unit I/F 55 to turn on the light-emitting device mounted in the SUB button 192 at Step S33. At this time, the reading portion 91 sets proxy data of proxy video displayed in the child screen 142 as the playback control object.

At Step S34, the reading portion 91 determines whether the PREV button 199 or the NEXT button 200 has been pressed by the user. If it is determined that the PREV button 199 or the NEXT button 200 has been pressed, the processing proceeds to Step S35. At Step S35, the reading portion 91 sets an FTC at the beginning of the clip immediately preceding or following the clip corresponding to the currently set child screen playback point as a new child screen playback point. Then, the processing procedure proceeds to Step S38.

On the other hand, if it is determined in Step S34 that the PREV button 199 or the NEXT button 200 has not been pressed, the processing procedure proceeds to Step S36. At Step S36, the reading portion 91 determines whether any of the playback control buttons has been pressed by the user.

If it is determined in Step S36 that any of the playback control buttons has been pressed, the reading portion 91 controls playback of the proxy data in accordance with the operation on the playback control button at Step S37. Specifically, the reading portion 91 sets the child screen playback point in accordance with the operation on the playback control button. For example, in accordance with an operation on the PLAY button 195, which is one of the playback control buttons, the reading portion 91 sets the frame following the currently set child screen playback point as a new child screen playback point. Then, the processing procedure proceeds to Step S38.

At Step S38, the playback object reading section 81 reads proxy data at the child screen playback point. Specifically, the reading portion 91 of the playback object reading section 81 reads annular proxy data in an annular set containing the proxy data at the child screen playback point from the optical disc 43 and supplies the read annular proxy data to the extracting portion 92. The extracting portion 92 stores the annular proxy data received from the reading portion 91 in the proxy area 72.

At Step S39, the synthesizing section 82 reads video data in the source data at the parent screen playback point from the source area 71 and also reads video data in the source video data at the child screen playback point from the proxy area 72. The synthesizing section 82 then synthesizes the source data and the proxy data so that the source video and the proxy video are simultaneously displayed in the parent screen 141 and the child screen 142, respectively. Then, the synthesizing section 82 supplies the synthesized data to the video display I/F 58.

At Step S40, the video display I/F 58 displays the source video at the parent screen playback point in the parent screen 141 and also displays the proxy video at the child screen playback point in the child screen 142 on the basis of the synthesized data received from the synthesizing section 82. At this time, the output section 83 reads audio data in the proxy data at the child screen playback point from the proxy area 72 and supplies the read audio data to the speaker 45 via the audio output I/F 56 to output sound corresponding to the audio data. In other words, the output section 83 outputs sound corresponding to the playback control object from the speaker 45.

At Step s41, the editing section 84 determines whether the IN button 173 and the ENTRY button 171 have been pressed simultaneously by the user. If it is determined in Step S41 that the IN button 173 and the ENTRY button 171 have not been pressed simultaneously, the processing procedure returns to Step S34 and the processing described above is repeated.

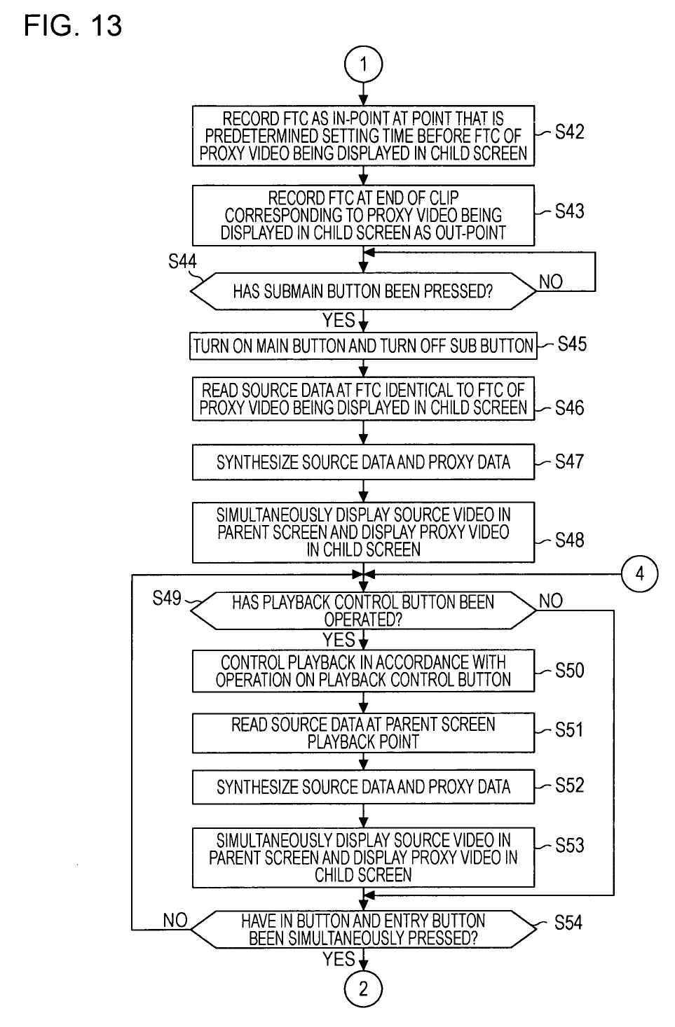

On the other hand, if it is determined in Step S41 that the IN button 173 and the ENTRY button 171 have been pressed simultaneously, at Step S42 in FIG. 13, the editing section 84 sets an FTC at a point that is a predetermined setting time before the FTC of the proxy video being displayed in the child screen 142 as the in-point and records the set in-point in the edit list created in the processing of Step S31.

Specifically, the editing section 84 acquires information representing the currently set child screen playback point from the reading portion 91 and sets an FTC at a point that is a predetermined setting time before the child screen playback point represented by the acquired information as the in-point and records the set in-point in the edit list. At this time, the editing section 84 also records information such as the UMID of a clip corresponding to the proxy data at the child screen playback point, the position based on FTC in the edit list of the beginning of the source data in an editing section corresponding to the recorded in-point, a playback channel, and an output channel.

Note that although channels 1 to 4 are designated beforehand as the playback channel and the output channel, it is also possible that the user determines a playback channel and an output channel. In this case, the editing operation part 160 may be provided with a button for setting the playback channel and output channel.

At Step S43, the editing section 84 records an FTC at the end of a clip corresponding to the proxy video being displayed in the child screen 142 in the edit list as the out-point. At Step S44, the reading portion 91 determines whether the SUBMAIN button 182 has been pressed. If it is determined that the SUBMAIN button 182 has not been pressed, the reading portion 91 waits until the sub-main button 182 is pressed.

On the other hand, if it is determined in Step S44 that the sub-main button 182 has been pressed, the reading portion 91 controls the operation unit I/F 55 to turn on the light-emitting device mounted in the MAIN button 191 and turn off the light-emitting device mounted in the SUB button 192 at Step S45. At this time, the reading portion 91 sets the parent screen playback point at a position identical to the position of the child screen playback point and sets the source data of the source video displayed in the parent screen 141 as the playback control object.

At Step S46 the playback object reading section 81 reads source data at the FTC identical to the FTC of the proxy video being displayed in the child screen 142 from the optical disc 43. Specifically, the reading portion 91 reads from the optical disc 43 an annular set containing the source data at the parent screen playback point which is set at the position identical to the position of the child screen playback point and supplies the annular set to the extracting portion 92. The extracting portion 92 separates annular video data and annular audio data from the annular set received from the reading portion 91. The extracting portion 92 controls the temporary storage memory I/F 53 to stores the annular video data and the annular audio data in the source area 71 of the temporary storage memory 64.

At Step S47, similarly to the processing of Step S39, the synthesizing section 82 reads video data in the source video data at the parent screen playback point from the source area 71 and also reads video data in the proxy data at the child screen playback point from the proxy area 72. Then, the synthesizing section 82 synthesizes the pieces of video data and supplies the synthesized data to the video display I/F 58.

At Step S48, similarly to the processing of Step S40, the video display I/F 58 displays the source video at the parent screen playback point in the parent screen 141 and the proxy video at the child screen playback point in the child screen 142 on the basis of the synthesized data received from the synthesizing section 82. At this time, the output section 83 outputs sound corresponding to the source video displayed in the parent screen 141 from the speaker 45.

During a time period in which processing for storing the source data in the source area 71, the synthesizing section 82 reads the video data in the proxy data at the child screen playback point and video data in the proxy data at the parent screen playback point stored in the proxy area 72 and synthesizes the pieces of video data. As a result, proxy video identical to the proxy video displayed in the child screen 142 is displayed in the parent screen 141. An example of a technique for displaying proxy video during a time period in which processing for storing the source data is performed as described above is disclosed in United State Patent Application Publication No. 2004/0076397.

At Step S49, similarly to the processing of Step S36 in FIG. 12, the reading portion 91 determines whether any of the playback control buttons has been pressed. If it is determined that any of the playback control buttons has not been pressed, the processing procedure proceeds to Step S54.

On the other hand, if it is determined in Step S49 that any of the playback control buttons has pressed, the reading portion 91 controls playback of the source data in accordance with the operation on the playback control button at Step S50. Specifically, the reading portion 91 sets a parent screen playback point in accordance with the operation on the playback control buttons. In this case, a range within which the parent screen playback point is changed is limited from the in-point to the out-point recorded in the processing of Step S42 and Step S43, respectively.

At Step S51, the playback object reading section 81 reads the source data at the parent screen playback point set in Step S50 from the optical disc 43. Specifically, the reading portion 91 of the playback object reading section 81 reads an annular set containing the source video data at the parent screen playback point from the optical disc 43 and supplies the read annular set to the extracting portion 92. The extracting portion 92 extracts the source data from the annular set received from the reading portion 91 and stores the extracted source data in the source area 71 of the temporary storage memory 64.

In a case where the playback speed is high, the playback object reading section 81 does not read the source data at the parent screen playback point but reads proxy data at the parent screen playback point.

At Step S52, similarly to the processing of Step S47, the synthesizing section 82 reads video data in the source data at the parent screen playback point from the source area 71 and also reads video data in the proxy data at the child screen playback point from the proxy area 72. Then, the synthesizing section 82 synthesizes the pieces of video data and supplies the synthesized data to the video display I/F 58.

At Step S53, similarly to the processing of Step S48, the video display I/F 58 displays the source video at the parent screen playback point in the parent screen 141 and also displays the proxy video at the child screen playback point in the child screen 142, on the basis of the synthesized data received from the synthesizing section 82. At this time, the output section 83 outputs audio corresponding to the source video displayed in the parent screen 141 from the speaker 45.

At Step S54, similarly to the processing of Step S41 in FIG. 12, the editing section 84 determines whether the IN button 173 and the ENTRY button 171 has been pressed simultaneously by a user. If it is determined that the IN button 173 and the ENTRY button 171 has not been pressed simultaneously, the processing procedure returns to Step S49 and the processing described above is repeated.

On the other hand, if it is determined in Step S54 that the IN button 173 and the ENTRY button 171 has been pressed simultaneously, the editing section 84 changes the in-point recorded in the edit list in the processing of Step S42 or Step S55 to the FTC of the source video being displayed in the parent screen 141. Specifically, the editing section 84 acquires information indicating the currently set parent screen playback point from the reading portion 91 and records the parent screen playback point indicated by the information in the edit list as the new in-point.

At Step S56, similarly to the processing of Step S32 in FIG. 12, the reading portion 91 determines whether the SUB button 192 has been pressed by the user. If it is determined that the SUB button 192 has not been pressed, the processing procedure proceeds to Step S57.

Processing of Step S57 through Step S61 is similar to the processing of Step S49 through Step S53 in FIG. 13, and thus the description thereof will be omitted.

At Step S68, the synthesizing section 82 synthesizes video data in the source data at the parent screen playback point, i.e., the in-point recorded in the edit list in the processing of Step S55 and video data in the proxy data at the child screen playback point. As a result, the source video at the in-point is displayed in the parent screen 141 and proxy video at the child screen playback point specified by the user using the playback control buttons is displayed in the child screen 142. Thus, while viewing the source video corresponding to the in-point, the user can search for proxy data corresponding to an FTC set as the out-point to be followed by the in-point by operating the playback control buttons. This arrangement enhances operability for users.

At Step S62, the synthesizing section 82 determines whether the IN button 173 and the DELETE button 172 have been pressed simultaneously by the user. If it is determined that the IN button 173 and the DELETE button 172 has not been pressed simultaneously, the processing procedure returns to Step S56 and the processing described above is repeated.

On the other hand, if it is determined in Step S62 that the IN button 173 and the DELETE button 172 have been pressed simultaneously, the editing section 84 deletes the recording of the in-point around the FTC corresponding to the source video being displayed in the parent screen 141 from the edit list at Step S63. Specifically, the editing section 84 acquires information indicating the currently set parent screen playback point from the reading portion 91 and searches the edit list for the description of the in-point around the parent screen playback point indicated by the information. Then, the editing section 84 deletes the description of the in-point. Then, the processing procedure returns to Step S49 in FIG. 13 and the processing described above is repeated. As a result, the in-point to be recorded in the edit list is corrected.

If it is determined in Step S56 that the SUB button 192 has been pressed, the reading portion 91 controls the operation unit I/F 55 to turn on the light-emitting device mounted in the SUB button 192 and turn off the light-emitting device mounted in the main-button 191. At this time, the reading portion 91 sets the proxy data of the video proxy being displayed in the child screen 142 as the playback control object.

The processing of Step S65 through Step S69 is similar to the processing of Step S36 through Step S40, and thus the description thereof will be omitted. At Step S70, the editing section 84 determines whether the OUT button 174 and the ENTRY button 171 have been pressed simultaneously by the user. If it is determined that the OUT button 174 and the ENTRY button 171 have not been pressed simultaneously, the processing procedure returns to Step S65 and the processing described above is repeated.

On the other hand, if it is determined in Step S70 that the OUT button 174 and the ENTRY button 171 have been pressed simultaneously, the editing section 84 changes the out-point, which is recorded in the edit list in the processing of Step S43 in FIG. 13, to an FTC at a point that is a predetermined setting time after the FTC of the proxy video being displayed in the child screen 142.

The processing of Step S72 through Step S81 is similar to the processing of Step S44 through Step S53 in FIG. 13, and thus the description thereof will be omitted.

At Step S82, the editing section 84 determines whether the OUT button 174 and the ENTRY button 171 have been pressed simultaneously by a user. If it is determined that the OUT button 174 and the ENTRY button 171 have not been pressed simultaneously, the processing procedure returns to Step S77, and the processing described above is repeated.

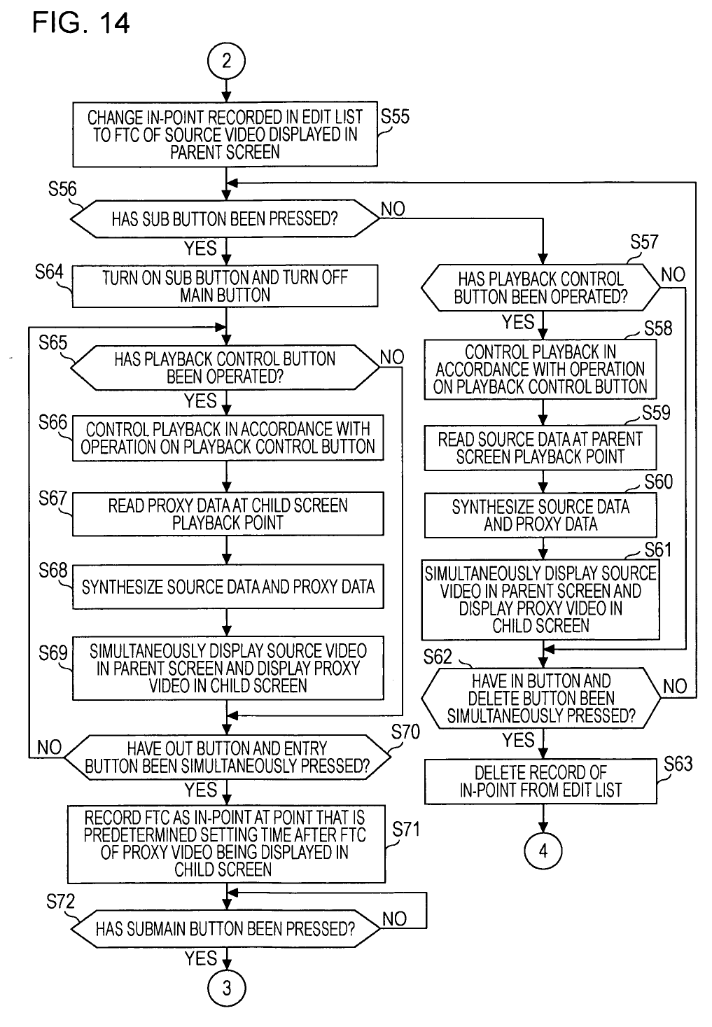

On the other hand, if it is determined in Step S82 that the OUT button 174 and the ENTRY button 171 have been pressed simultaneously, the editing section 84 changes the out-point, which was changed in the processing of Step S71 in FIG. 14 or Step 83, to the FTC of video being displayed in the parent screen 141 at Step S83.

At Step S84, the editing section 84 whether the editing processing is to be terminated, i.e., whether the START/STOP button 175 has been pressed by the user. If it is determined that the editing processing is to be terminated, the processing procedure is terminated.

On the other hand, if it is determined in Step S84 that the editing processing is not to be terminated, similarly to the processing of Step S56 in FIG. 14, the reading portion 91 determines whether the SUB button 192 has been pressed by the user at Step S85. If it is determined in Step S85 that the SUB button 192 has been pressed, the processing procedure returns to Step S33 in FIG. 12, and the processing described above is repeated.

In this case, at Step S39, the synthesizing section 82 synthesizes video data in the source data at the parent screen playback point, i.e., the out-point recorded in the edit list in the processing of Step S83, and video data in the proxy data at the child screen playback point. As a result, the source video at the out-point is displayed in the parent screen 141 and proxy video at the child screen playback point, which is set on the basis of an operation performed by the user on the PREV button 199 or the NEXT button 200, or the playback control buttons, is displayed in the child screen 142. Thus, the user can operates the PREV button 199 or the NEXT button 200, or the playback control buttons while viewing the source video corresponding to the out-point so as to search for the proxy video corresponding to an FTC set as the in-point to be connected to the out-point. This arrangement enhances operability in editing processing.

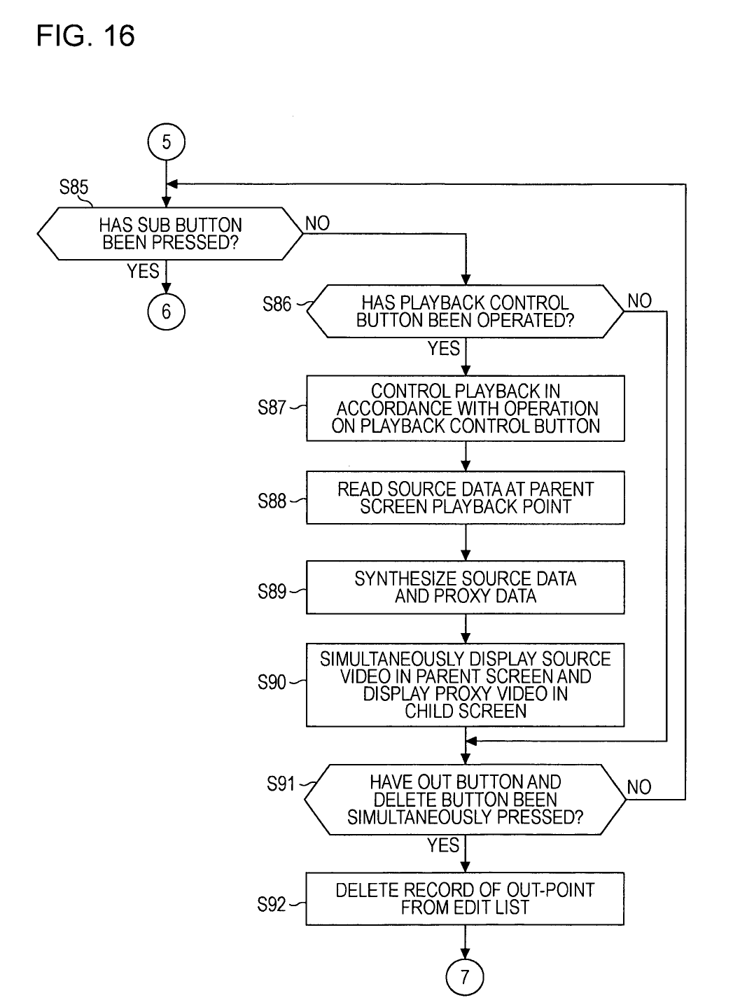

On the other hand, if it is determined in Step S85 that the SUB button 192 has not been pressed, the processing procedure proceeds to Step S86 in FIG. 16. The processing of Step S86 through Step S90 is similar to the processing of Step S57 through Step S61, and thus the description thereof will be omitted.

At Step S91, the editing section 84 determines whether the OUT button 174 and the DELETE button 172 have been pressed simultaneously by the user. If it is determined that the OUT button 174 and the DELETE button 172 have not been pressed simultaneously, the processing procedure returns to Step S85, and the processing described above is repeated.

On the other hand, if it is determined in Step S91 that the OUT button 174 and the DELETE button 172 have been pressed simultaneously, the editing section 84 deletes the record of the out-point around the FTC of the source video being displayed in the parent screen 141 from the edit list at Step S92. Then, the processing procedure returns to Step S77 in FIG. 15, and the processing described above is repeated. As a result, the out-point to be recorded in the edit list is corrected.

Note that the sizes of the parent screen 141 and the child screen 142 may be different or the same. The number of screens provided in the display device 46 for simultaneously displaying editing video images may exceed two. Further, it is also possible that source video is displayed in both the parent screen 141 and the child screen 142 and that proxy video is displayed in both the parent screen 141 and the child screen 142.

In addition, in this description, the steps for describing programs to be stored in program storage media may include not only processing executed in time series in the described order but also processing executed in parallel or individually and not necessarily in time series.

It should be understood by those skilled in the art that various modifications, combinations, sub-combinations and alterations may occur depending on design requirements and other factors insofar as they are within the scope of the appended claims or the equivalents thereof.

What is claimed is:

1. A playback apparatus playing back video data and low-resolution data obtained by decreasing the resolution of the video data, the video data and the low-resolution data being stored in a recording medium, the playback apparatus comprising:
a reading unit configured to read the video data and the low-resolution data from the recording medium;
a synthesizing unit configured to synthesize the read video data and the read low-resolution data; and
a display control unit configured to, on the basis of synthesized data obtained as a result of the synthesis, simultaneously display source video corresponding to the video data in a first screen of a display device and low-resolution video corresponding to the low-resolution data in a second screen of the display device, the second screen being smaller than the first screen.

2. The playback apparatus of claim 1, further comprising:
a low-resolution specifying unit configured to specify a time code value of low-resolution video to be displayed in the second screen;
a start point specifying unit configured to specify a time code value of low-resolution video displayed in the second screen as a start point of an editing section, the editing section being a section of source video to be edited;
an instructing unit configured to instruct display of source video in the first screen, the source video corresponding to a time code value identical to a time code value of low-resolution video currently displayed in the second screen;
an end point specifying unit configured to specify a time code value of low-resolution video displayed in the second screen as an end point of the editing section; and
an editing unit configured to record the specified start point and the specified end point of the editing section in the recording medium as editing information representing a result of editing,
wherein, in response to an instruction sent by the instructing unit, the synthesizing unit synthesizes low-resolution data of low-resolution video currently displayed in the second screen and video data of source video corresponding to a time code value identical to the time code value of the currently displayed low-resolution video, and when a time code value of low-resolution video is specified by the low-resolution specifying unit, synthesizes low-resolution data corresponding to the specified time code value and video data of source video corresponding to a time code value identical to the time code value of low-resolution video displayed in the second screen at the time of the instruction by the instructing unit.

3. The playback apparatus of claim 1, further comprising:
a low-resolution specifying unit configured to specify a time code value of low-resolution video to be displayed in the second screen;
a display instructing unit configured to instruct display of source video in the first screen, the source video corresponding to a time code value identical to a time code value of low-resolution video currently displayed in the second screen;
a change instructing unit configured to instruct a change in a time code value of source video to be displayed in the first screen from a time code value of source video displayed in the first screen at the time of the instruction by the display instructing unit to a desired time code value of source video;
a start point specifying unit configured to specify a time code value of source video displayed in the first screen as a start point of an editing section, the editing section being a section of source video to be edited;
an end point specifying unit configured to specify a time code value of source video displayed in the first screen as an end point of the editing section; and
an editing unit configured to record the specified start point and the specified end point of the editing section in the recording medium as editing information representing a result of editing,
wherein, in response to an instruction sent by the display instructing unit, the synthesizing unit synthesizes low-resolution data of low-resolution video currently displayed in the second screen and video data of source video corresponding to a time code value identical to a time code value of the currently displayed low-resolution video, and when a time code value is specified by the low-resolution specifying unit, the synthesizing unit synthesizes low-resolution data corresponding to the specified time code value and video data of source video displayed in the first screen at an immediately preceding time point and, in response to an instruction by the change instructing unit, synthesizes low-resolution data of low-resolution video displayed in the second screen at an immediately preceding time point and video data corresponding to the desired time code value of source video.

4. A playback method for a playback apparatus playing back video data and low-resolution data obtained by decreasing the resolution of the video data, the video data and the low resolution data being recorded in a recording medium, the playback method comprising the steps of:
reading the video data and the low-resolution data from the recording medium;
synthesizing the read video data and the read low-resolution data; and
on the basis of synthesized data obtained as a result of the synthesizing, simultaneously displaying source video corresponding to the video data in a first screen of a display device and low-resolution video corresponding to the low-resolution data in a second screen of the display device, the second screen being smaller than the first screen.

5. A program causing a computer to perform playback processing for playing back video data and low-resolution data obtained by decreasing the resolution of the video data, the video data and the low resolution data being recorded in a recording medium, the playback processing comprising the steps of:
reading the video data and the low-resolution data from the recording medium;
synthesizing the read video data and the read low-resolution data; and
on the basis of synthesized data obtained as a result of the synthesizing, simultaneously displaying source video corresponding to the video data in a first screen of a display device and low-resolution video corresponding to the low-resolution data in a second screen of the display device, the second screen being smaller than the first screen.
